(19) United States
(12) Patent Application Publication
(10) Pub. No.: US 2010/0056176 A1
(43) Pub. Date: Mar. 4, 2010

(54) SYSTEM AND METHOD FOR TRANSMITTING POSITION INFORMATION OF A COMMUNICATION DEVICE

(75) Inventor: CHUNG-MING HSU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/340,763

(22) Filed: Dec. 22, 2008

(30) Foreign Application Priority Data
Aug. 28, 2008 (CN) 200810304273.X

(51) Int. Cl. H04W 24/00; G06F 15/16

(52) U.S. Cl. 455/456.1; 709/206

(57) ABSTRACT

A method and system for transmitting position information of a communication device includes: setting a startup command to activate a global position system (GPS) of the communication device, determining if the communication device has received a push mail including the startup command from a push mail server, activating the GPS to locate a position of the communication device, and acquiring corresponding position information. The method and system further includes generating a blank push mail, inserting the position information into the generated push mail, and transmitting the generated push mail to a predetermined receiver.

### BACKGROUND

1. Field of the Invention

Embodiments of the present disclosure relate to locating systems and methods, and more particularly to a system and method for transmitting position information of a communication device.

2. Description of Related Art

It is useful to find position of people or an object for different reasons. The position in-and-of itself is important because it allows another people to find something that is lost, such as a child or a piece of expensive equipment. The position also allows courier companies to arrange deliveries logically and efficiently. More and more communication devices are installed with global position systems (GPSs) to locate a position of the communication devices. However, if a person wants to find the user of the communication device, the person has to wait for the user to send corresponding position information.

In another example, if the communication device is lost, the owner of the communication device cannot know the position information of the communication device even though the communication device has the GPS.

What is needed, therefore, is an improved system and method for transmitting position information of the communication device to overcome the above-stated problems.

### BRIEF DESCRIPTION OF THE DRAWINGS

FIG. 1 is a block diagram of one embodiment of a system for transmitting position information of a communication device.

FIG. 2 is a block diagram of one embodiment of the communication device of FIG. 1.

FIG. 3 is a flowchart of one embodiment of a method for transmitting position information of a communication device.

FIG. 4 is a flowchart of one embodiment of a method for acquiring position information of a communication device by a push mail server.

### DETAILED DESCRIPTION OF CERTAIN INVENTIVE EMBODIMENTS

All of the processes described below may be embodied in, and fully automated via, functional code modules executed by one or more general purpose computers or processors. The code modules may be stored in any type of computer-readable medium or other storage device device. Some or all of the methods may alternatively be embodied in specialized computer hardware or communication apparatus.

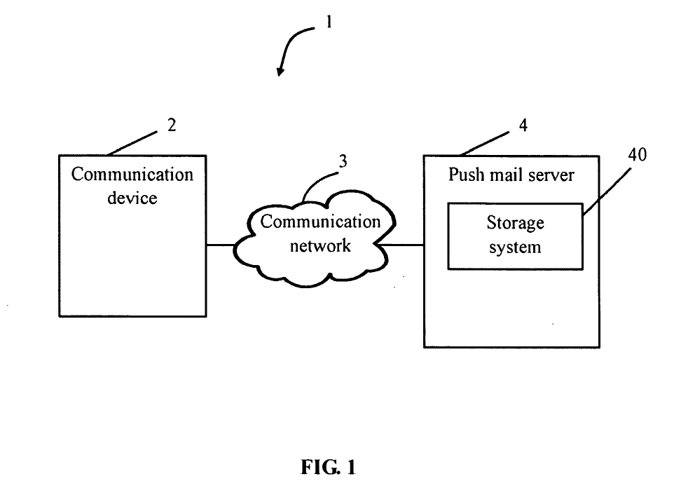

FIG. 1 is a block diagram of one embodiment of a system 1 for transmitting position information of a communication device (hereinafter referred to as “the transmitting system 1”). Depending on the embodiment of the present disclosure, the transmitting system 1 may include a communication device 2 and a push mail server 4. The communication device 2 may communicate with the push mail server 4 through a communication network 3. Depending on the embodiment, the communication network 3 may be the Global System for Mobile communication (GSM) network, the General Packet Radio Service (GPRS) network, or the Internet, for example. Depending on the embodiment, the communication device 2 may be a mobile phone, a personal digital assistant, or a computing device.

In one embodiment, the push mail server 4 may be a host computer, and includes a storage system 40 for storing various data, such as push mails, and position information received from the communication device 2, etc. The push mail server 4 provides a setting interface for setting relevant data of a push mail, such as a subject of the push mail, sender information, and receiver information. The sender information includes a phone number or an electronic mail (E-mail) address.

Depending on the embodiment of the present disclosure, technologies of “server push” and “client push” are adopted. Using “server push,” the communication device 2 may subscribe to predetermined information channels from the push mail server 4, and whenever new information is available on one of the predetermined information channels, the push mail server 4 pushes the new information out to the communication device 2 via a push mail. Using “client push,” the communication device 2 generates a push mail including specified data and sends the generated push mail to a predetermined receiver (i.e., the push mail server 4 or other mobile phones), when the communication device 2 receives preset data (i.e., a push mail including a preset command sent by the push mail server 4).

The transmitting system 1 is configured for setting a startup command to acquire position information of the communication device 2, receiving a push mail including the set startup command from the push mail server 4, acquiring the position information of the communication device 2, generating a blank push mail, inserting the position information into the generated push mail, and sending the generated push mail to a predetermined receiver.

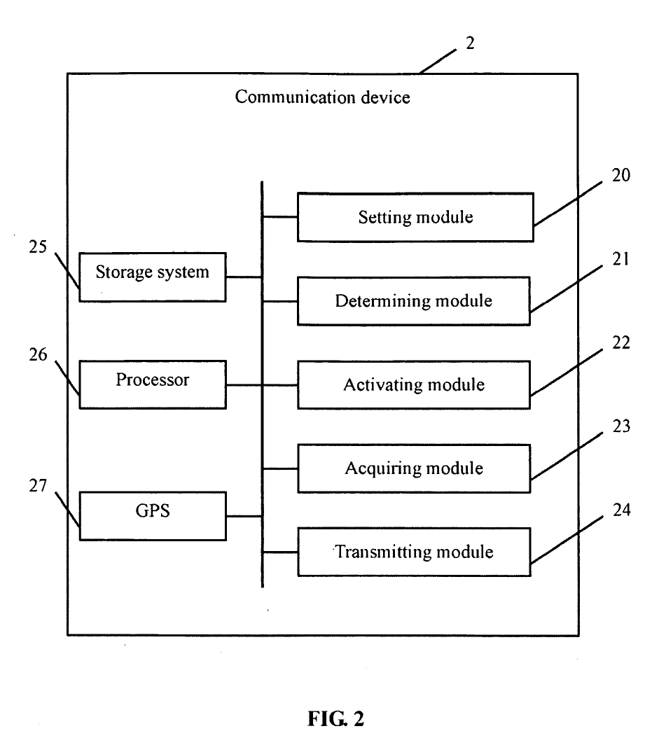

FIG. 2 is a block diagram of one embodiment of the communication device 2. In one embodiment, the communication device 2 includes a storage system 25, and a global position system (GPS) 27. The storage system 25 is used for storing various kinds of data, such as short messages, communication records, push mails, etc. Depending on the embodiment, the storage system 25 may include a memory of the communication device 2 or an external storing card, such as a memory stick, a Subscriber Identification Module (SIM) card, for example. The GPS 27 is used for locating a position of the communication device 2 in response to a corresponding command.

In one embodiment, the communication device 2 may include a setting module 20, a determining module 21, an activating module 22, an acquiring module 23, and a transmitting module 24. The modules 20, 21, 22, 23, and 24 may be used to perform one or more operations of the communication device 2. In another embodiment, the communication device 2 may include one or more specialized or general purpose processors, such as a processor 26 for executing at least one operation for the modules 20, 21, 22, 23, and 24.

The setting module 20 is configured for setting a startup command to activate the GPS 27 of the communication device 2. In one embodiment, the startup command may be a character string, which includes alphanumeric characters and/or symbols. In other embodiments, the startup command may be a segment of program, which may be executed by the processor 26 of the communication device 2.

Depending on the embodiment, a user may set relevant data of a push mail through the setting interface provided by the push mail server 4, such as a subject, sender information and receiver information. For example, the subject may be preset as “position acquisition,” the sender information may be preset as an E-mail address of “123@456.com,” and the receiver information may be preset as a phone number of the communication device 2. If the user wants to know a position of the communication device 2, the user may send a push mail from the E-mail address of “123@456.com” to the push mail server 4. Accordingly, the subject of the push mail is “position acquisition,” where the push mail includes the startup command. After receiving the push mail, the push mail server 4 transmits the push mail to the communication device 2 according to the phone number of the communication device 2.

The determining module 21 is configured for determining if a received push mail sent from the push mail server 4 includes the startup command.

The activating module 22 is configured for activating the GPS 27 of the communication device 2 to locate a position of the communication device 2 if the received push mail includes the startup command.

The acquiring module 23 is configured for acquiring position information of the communication device 2 from the GPS 27. The position information includes longitude, latitude, and altitude of the communication device 2.

The setting module 20 is further configured for presetting a template of a push mail to be sent by the communication device 2, and predetermining a receiver of the push mail to be sent by the communication device 2. The preset template of the push mail may include, but is not limited to a subject and a format of the push mail. The predetermined receiver may be the push mail server 4 or any other mobile phone.

The acquiring module 23 is further configured for generating a blank push mail according to the preset template of the push mail, and inserting the position information into the generated push mail according to the preset format of the push mail.

The transmitting module 24 is configured for transmitting the generated push mail to the predetermined receiver. In one embodiment, the predetermined receiver may be the push mail server 4 or any other mobile phones. By receiving the generated push mail from the communication device 2, the position information of the communication device 2 may be known.

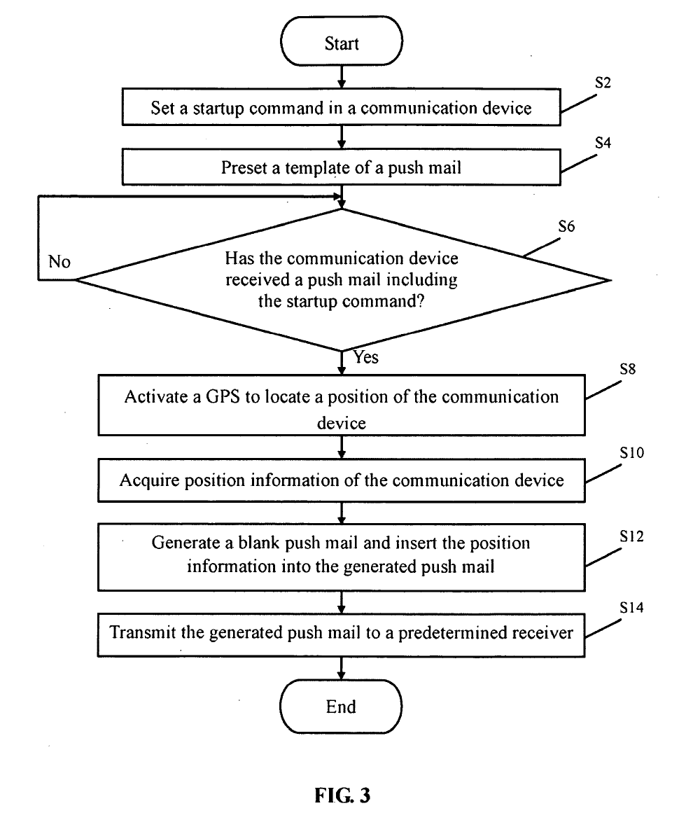

FIG. 3 is a flowchart of one embodiment of a method for transmitting position information of a communication device. The method of FIG. 3 may be used when a user has lost his/her communication device 2 and is trying to find the communication device 2. Depending on the embodiment, additional blocks may be added, others removed, and the ordering of the blocks may be replaced.

In block S2, the setting module 20 sets a startup command in the communication device 2 to activate the GPS 27 of the communication device 2 to locate a position of the communication device. In one embodiment, the startup command may be a character string or a segment of a program, which may be executed by the processor 26 of the communication device 2.

In block S4, the setting module 20 presets a template of a push mail to be sent by the communication device 2, and predetermines a receiver of the push mail to be sent by the communication device 2. The preset template of the push mail may include a subject and a format of the push mail. The predetermined receiver may be the push mail server 4 or any other mobile phone.

In block S6, the determining module 21 determines if the communication device 2 has received a push mail including the startup command from the push mail server 4. If the communication device 2 has received a push mail including the startup command from the push mail server 4, in block S8, the activating module 22 activates the GPS 27 of the communication device 2 to locate the position of the communication device 2. If the communication device 2 has not received a push mail including the startup command from the push mail server 4, the procedure returns to block S6.

In block S10, the acquiring module 23 acquires position information of the communication device 2 from the GPS 27. The position information includes longitude, latitude, and altitude of the communication device 2.

In block S12, the acquiring module 23 generates a blank push mail according to the preset template of the push mail, and inserts the position information into the generated push mail according to the preset format of the push mail.

In block S14, the transmitting module 24 transmits the generated push mail to the predetermined receiver. In one embodiment, the predetermined receiver may be the push mail server 4 or any other mobile phones.

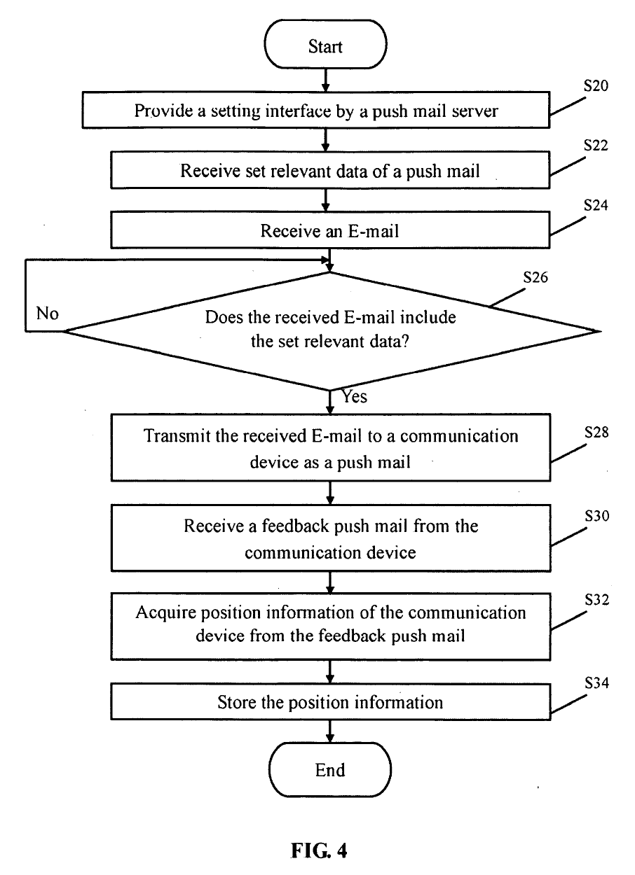

FIG. 4 is a flowchart of one embodiment of a method for acquiring position information of a communication device by a push mail server. Depending on the embodiment, additional blocks may be added, others removed, and the ordering of the blocks may be replaced.

In block S20, the push mail server 4 provides a setting interface for setting relevant data of a push mail sent to the communication device 2. The set relevant data of the push mail sent to the communication device 2 may include, but not limited to a subject of the push mail, sender information, and receiver information. In one embodiment, the receiver information is a phone number of the communication device 2.

In block S22, the push mail server 4 receives the set relevant data of the push mail in response to user input.

In block S24, the push mail server 4 receives an E-mail from an E-mail address or a mobile phone.

In block S26, the push mail server 4 determines if the received E-mail includes the set relevant data of the push mail sent to the communication device 2. If the received E-mail includes the set relevant data of the push mail sent to the communication device 2, in block S28, the push mail server 4 transmits the received E-mail to the communication device 2 as a push mail, according to the phone number of the communication device 2. If the received E-mail does not include the set relevant data of the push mail sent to the communication device 2, the procedure returns to block S26.

In block S30, the push mail server 4 receives a feedback push mail from the communication device 2. As described in FIG. 3, the feedback push mail sent from the communication device 2 may include position information of the communication device 2.

In block S32, the push mail server 4 acquires the position information of the communication device 2 from the feedback push mail.

In block S34, the push mail server 4 stores the position information of the communication device 2 in a storage system 40 of the push mail server 4. The stored position information may be read by a sender of the E-mail so as to find where the communication device 2 or the user of the communication device 2 is.

In FIG. 4, the push mail server 4 is predetermined to be a receiver of the push mail sent by the communication device 2, in other embodiments, other mobile phones may be predetermined to be the receiver.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A system for transmitting position information of a communication device, the communication device in communication with a push mail server via a communication network, the communication device comprising a global position system (GPS), the system comprising:
a setting module configured for setting a startup command to activate the GPS of the communication device to locate a position of the communication device, presetting a template of a push mail to be sent by the communication device, and predetermining a receiver of the push mail to be sent by the communication device;
a determining module configured for determining if a received push mail sent from the push mail server comprises the startup command;
an activating module configured for activating the GPS of the communication device to locate the position of the communication device if the received push mail comprises the startup command;
an acquiring module configured for acquiring position information of the communication device from the GPS, generating a blank push mail according to the preset template of the push mail, and inserting the position information into the generated push mail;
a transmitting module configured for transmitting the generated push mail to the predetermined receiver; and
at least one processor that executes the setting module, the determining module, the activating module, the acquiring module, and the transmitting module.

2. The system according to claim 1, wherein the push mail server provides a setting interface for setting relevant data of a push mail, receives an electronic mail (E-mail) comprising the set relevant data of the push mail, and sends the received E-mail to the communication device as the push mail.

3. The system according to claim 1, wherein the predetermined receiver is the push mail server or a mobile phone.

4. The system according to claim 1, wherein the position information comprises longitude, latitude, and altitude of the communication device.

5. The system according to claim 1, wherein the startup command is a character string comprising alphanumeric characters and/or symbols.

6. The system according to claim 1, wherein the template of the push mail to be sent by the communication device comprises a subject and a format of the push mail.

7. A method for transmitting position information of a communication device, the communication device in communication with a push mail server via a communication network, the method comprising:
setting a startup command to activate a global position system (GPS) of the communication device to locate a position of the communication device;
presetting a template of a push mail to be sent by the communication device, and predetermining a receiver of the push mail to be sent by the communication device;
determining if the communication device has received a push mail from the push mail server;
determining if the received push mail comprises the startup command if the communication device has received the push mail from the push mail server;
activating the GPS of the communication device to locate the position of the communication device if the received push mail comprises the startup command;
acquiring position information of the communication device from the GPS;
generating a blank push mail according to the preset template of the push mail, and inserting the position information into the generated push mail; and
transmitted the generated push mail to the predetermined receiver.

8. The method according to claim 7, wherein the push mail server provides a setting interface for setting relevant data of a push mail, receives an electronic mail (E-mail) comprising the set relevant data of the push mail, and sends the received E-mail to the communication device as a push mail.

9. The method according to claim 7, wherein the predetermined receiver is the push mail server or a mobile phone.

10. The method according to claim 7, wherein the position information comprises longitude, latitude, and altitude of the communication device.

11. The method according to claim 7, wherein the startup command is a character string comprising alphanumeric characters and/or symbols.

12. The method according to claim 7, wherein the template of the push mail to be sent by the communication device comprises a subject and a format of the push mail.

13. A computer-implemented method for acquiring position information of a communication device by a push mail server via a communication network, the method comprising:
providing a setting interface for setting relevant data of a push mail;
receiving the set relevant data of the push mail, the set relevant data comprising a phone number of the communication device;
receiving an electronic mail (E-mail) comprising the set relevant data of the push mail;
sending the received E-mail to the communication device as a push mail according to the phone number of the communication device;
receiving a feedback push mail from the communication device;
acquiring position information of the communication device from the feedback push mail; and
storing the position information in a storage system of the push mail server.

14. The method according to claim 13, wherein the set relevant data of the push mail comprises a subject, sender information, and a format of the push mail.

15. The method according to claim 14, wherein the sender information comprises a phone number or an E-mail address.
